(19) United States
(12) Patent Application Publication
(10) Pub. No.: US 2005/0266239 A1
(43) Pub. Date: Dec. 1, 2005

(54) Retardation pressure-sensitive adhesive layer and method of producing the same, pressure-sensitive adhesive optical film and method of producing the same, and image display

(75) Inventors: Masayuki Satake, Osaka (JP); Akiko Ogasawara, Osaka (JP); Yuusuke Toyama, Osaka (JP); Fumiaki Shirafuji, Ohtsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi (JP)

(21) Appl. No.: 11/193,370

(22) Filed: Aug. 1, 2005

(30) Foreign Application Priority Data
Feb. 8, 2004 (JP) 2004-225741

(51) Int. Cl. C09K 19/00

(52) U.S. Cl. 428/354; 428/343

(57) ABSTRACT

A retardation pressure-sensitive adhesive layer of the present invention comprises a stretched pressure-sensitive adhesive layer obtained by stretching an optically-transparent pressure-sensitive adhesive layer, and the stretched pressure-sensitive adhesive layer has a retardation imparted by stretching. The retardation pressure-sensitive adhesive layer can provide a pressure-sensitive adhesive optical film which functions as a pressure-sensitive adhesive layer and functions as an optical compensation layer.

### BACKGROUND OF THE INVENTION

1. Field of the Invention

The invention relates to a retardation pressure-sensitive adhesive layer having a retardation imparted by stretching and a method of producing the same. The invention also relates to a pressure-sensitive adhesive optical film comprising a retardation pressure-sensitive adhesive layer and a method of producing the same. Examples of the optical film include a polarizing plate, a retardation plate, an optical compensation film, a brightness enhancement film, and a laminate thereof. The invention also relates to an image display such as a liquid crystal display, an organic EL display and a PDP using the pressure-sensitive adhesive optical films.

2. Description of the Related Art

In liquid crystal displays or the like, a polarizer is disposed as an indispensable component on both sides of a liquid crystal cell to because of the image-forming system, and generally, polarizing plates are attached. In addition to the polarizing plate, liquid crystal panels include an optical compensation film such as a retardation plate, which is laminated on the polarizing plate in order to make optical compensation for the liquid crystal panels and to improve viewing quality. Thinner films are proposed for the optical compensation film, because thin liquid crystal displays have been developed and cost reduction has been required for the production of large screens. It is also proposed that the optical compensation layer is formed by a coating method in place of the film.

In most cases, a pressure-sensitive adhesive is used when the optical film such as the polarizing plate is formed on the surface of the liquid crystal panels. A pressure-sensitive adhesive optical film comprising an optical film and a pressure-sensitive adhesive layer previously laminated on one side of the optical film is generally used. Such a pressure-sensitive adhesive optical film has the advantage that it can easily be fixed and no drying process is required for fixation.

It is required that the pressure-sensitive adhesive layer to be laminated onto the optical film should be generally colorless and transparent and not change over time by environmental stress such as heat and humidity. When the pressure-sensitive adhesive polarizing plates are disposed at upper and lower sides of a liquid crystal display, the pressure-sensitive adhesive layer in the polarizing plate is disposed on the liquid crystal cell. In this case, if the pressure-sensitive adhesive layer has retardation, depolarization can be caused at that portion, then exert a bad influence upon display and visibility such as a reduction in contrast. Thus, the pressure-sensitive adhesive layers having no retardation are generally selected. In this point of view, the acrylic adhesives are often used to form the pressure-sensitive adhesive layer for the pressure-sensitive adhesive optical film.

It is disclosed that a birefringent layer is formed with an aligned and cured product of a liquid crystal monomer to give a birefingence and allowed to function as an adhesive layer (Japanese Patent Application publication (JP-B) No. 08-27438). According to the above Patent Publication, however, the surface of a prism, which is an adherend, is applied with aligned polymer layer for the purpose of imparting birefringence, and thus the restriction that the adherend must have alignment is required. The above Patent Publication includes the term “adhesive” but is silent on the idea of the pressure-sensitive adhesion for easy fixation of the optical film.

### SUMMARY OF THE INVENTION

It is an object of the invention to provide a pressure-sensitive adhesive layer that has retardation and is formed by a method other than the method of aligning and curing the liquid crystal monomers and to provide a method of producing the same.

It is another object of the invention to provide a pressure-sensitive adhesive optical film in which a pressure-sensitive adhesive layer having retardation is laminated on the optical film and to provide a method of producing the same.

It is yet another object of the invention to provide image displays using the pressure-sensitive adhesive optical film.

In order to solve the above problems, the inventors have made active investigations and finally found the retardation pressure-sensitive adhesive layer and the like as described below in completing the invention.

Thus, the invention is directed to a retardation pressure-sensitive adhesive layer, comprising a stretched pressure-sensitive adhesive layer obtained by stretching an optically-transparent pressure-sensitive adhesive layer; and the stretched pressure-sensitive adhesive layer has a retardation imparted by stretching.

The retardation pressure-sensitive adhesive layer of the invention is based on the finding that a stretched pressure-sensitive adhesive layer obtained by stretching an optically-transparent pressure-sensitive adhesive layer has retardation. In contrast to conventional techniques, the pressure-sensitive adhesive layer was positively imparted retardation so as to serve an optical compensation function. The retardation pressure-sensitive adhesive layer of the invention functions as a pressure-sensitive adhesive layer and functions as an optical compensation layer because of having retardation and thus has adhesion properties and optical compensation functions at the same time. The pressure-sensitive adhesive optical film in which the retardation pressure-sensitive adhesive layer of the invention is laminated on an optical film has the optical compensation function from the retardation pressure-sensitive adhesive layer without using a retardation plate to be laminated with the optical film. Since the pressure-sensitive adhesive layer can also function as a retardation layer, a thin pressure-sensitive adhesive optical film can be formed with it.

The invention is also directed to a method of producing the above retardation pressure-sensitive adhesive layer, comprising a step of stretching an optically-transparent pressure-sensitive adhesive layer so that retardation is imparted to the optically-transparent pressure-sensitive adhesive layer by stretching.

In the above retardation pressure-sensitive adhesive layer, the stretched pressure-sensitive adhesive layer preferably has a crosslinked structure. The pressure-sensitive adhesive layer with the crosslinked structure can retain reliability and its shape at high temperatures.

In the above retardation pressure-sensitive adhesive layer, the optically-transparent pressure-sensitive adhesive layer is preferably formed by a pressure-sensitive adhesive containing a base polymer and a crosslinking agent. As mentioned above, the pressure-sensitive adhesive layer preferably has a crosslinked structure, the optically-transparent pressure-sensitive adhesive layer formed by a pressure-sensitive adhesive containing a base polymer and a crosslinking agent can realize such a crosslinked structure in a preferred manner.

The invention is also directed to a method of producing the above retardation pressure-sensitive adhesive layer, comprising steps of stretching an optically-transparent pressure-sensitive adhesive layer containing a crosslinking component whose crosslinking reaction is not completed; and then completing the crosslinking reaction of the crosslinking component.

The method of producing the retardation pressure-sensitive adhesive layer according to the invention may be performed by stretching an optically-transparent pressure-sensitive adhesive layer. In order to produce the pressure-sensitive adhesive layer with a crosslinked structure, the method preferably includes the steps of stretching the pressure-sensitive adhesive layer containing a crosslinking component in such a state that the crosslinking reaction of the crosslinking component is not completed, and then completing the crosslinking reaction. If the crosslinking reaction is completed before the stretching, the tendency of the resulting retardation pressure-sensitive adhesive layer to turn back to the original state sometimes cannot be suppressed so that the stretched state can be cancelled and the desired retardation cannot be achieved.

The invention is also directed to a pressure-sensitive adhesive optical film, comprising an optical film and at least one layer of the above retardation pressure-sensitive adhesive layer laminated on one side or both sides of the optical film.

For example, a pressure-sensitive adhesive polarizing plate in which the retardation pressure-sensitive adhesive layer is provided on a polarizing plate, the pressure-sensitive adhesive polarizing plate can provide an optical compensation function from the retardation pressure-sensitive adhesive layer without using a separate retardation plate to be laminated with the polarizing plate and can be used as an elliptically polarizing plate. In addition, the pressure-sensitive adhesive polarizing plate may be used in combination with a retardation plate or the like having an optical compensation function so as to provide an improved optical compensation function.

The invention is also directed to a method of producing a pressure-sensitive adhesive optical film, comprising a step of stretching a pressure-sensitive adhesive optical film containing an optical film and an optically-transparent pressure-sensitive adhesive layer laminated on one side or both sides of the optical film so that a retardation is imparted to the optically-transparent pressure-sensitive adhesive layer by the stretching.

The pressure-sensitive adhesive optical film comprising the retardation pressure-sensitive adhesive layer may be produced by laminating the retardation pressure-sensitive adhesive layer to an optical film or by stretching a pressure-sensitive adhesive optical film comprising an optical film and an optically-transparent pressure-sensitive adhesive layer in such a manner that the optical film and the pressure-sensitive adhesive layer are stretched.

In the method of producing the pressure-sensitive adhesive optical film, the optically-transparent pressure-sensitive adhesive layer preferably contains a crosslinking component and is preferably laminated on the optical film in such a state that the crosslinking reaction of the crosslinking component is not completed, and completing the crosslinking reaction of the crosslinking component after the stretching. In the method of producing the pressure-sensitive adhesive optical film, the optically-transparent pressure-sensitive adhesive layer is also preferably formed by a pressure-sensitive adhesive containing a base polymer and a crosslinking agent.

The invention is also directed to a pressure-sensitive adhesive optical film obtained by the above method.

The invention is also directed to an image display, comprising at least one of the above pressure-sensitive adhesive optical films.

### DESCRIPTION OF THE PREFERRED EXAMPLES

The retardation pressure-sensitive adhesive layer of the invention is a stretched pressure-sensitive adhesive layer obtained by stretching an optically-transparent pressure-sensitive adhesive layer; the stretched pressure-sensitive adhesive layer has a retardation imparted by stretching.

The optically-transparent pressure-sensitive adhesive layer has transparency in the visible light range and preferably has a total light transmittance of at least 40%. The transmittance of the pressure-sensitive adhesive layer may be measured using a high-speed spectrophotometer (model DOT-3 manufactured by Murakami Color Research Laboratory).

Any suitable pressure-sensitive adhesive may properly be used to form the optically-transparent pressure-sensitive adhesive layer, but the kind of the pressure-sensitive adhesive is not limited. Examples of the pressure-sensitive adhesive include rubber-based pressure-sensitive adhesives, acrylic-based pressure-sensitive adhesives, silicone-based pressure-sensitive adhesives, urethane-based pressure-sensitive adhesives, vinyl alkyl ether-based pressure-sensitive adhesives, polyvinyl alcohol-based pressure-sensitive adhesives, polyvinylpyrrolidone-based pressure-sensitive adhesives, polyacrylamide-based pressure-sensitive adhesives, and cellulose-based pressure-sensitive adhesives.

Among these adhesives, pressure-sensitive adhesives having good optical transparency and good weather resistance, heat resistance or the like and showing suitable adhesive properties such as suitable wettability, cohesiveness and adhesion are preferably used. Acrylic-based pressure-sensitive adhesives can exhibit such properties and are preferably used.

Acrylic-based pressure-sensitive adhesives comprise an acrylic base polymer having a main structure of an alkyl (meth)acrylate monomer unit. The term “(meth)acrylate” means an acrylate and/or a methacrylate, and “(meth)” has the same meaning in the description. The average carbon number of the alkyl group of the alkyl (meth)acrylate forming the main structure of the acrylic polymer may be about 1 to about 12. Examples of the alkyl (meth)acrylate include methyl (meth)acrylate, ethyl (meth)acrylate, butyl (meth)acrylate, and 2-ethylhexyl (meth)acrylate. Any of these may be used alone or in any combination. In particular, C₁₋₉ alkyl (meth)acrylate is preferred.

For the purpose of improving adhesion and heat resistance, the acrylic polymer may be a copolymer containing one or more types of other monomers unites. Examples of such copolymerization monomers include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as (meth)acrylic acid, carboxyethyl (meth)acrylate, carboxypentyl (meth)acrylate, itaconic acid, maleic acid, fumaric acid and crotonic acid; acid anhydride group-containing monomers such as maleic anhydride and itaconic anhydride; caprolactome addition products of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphoric acid group-containing monomers such as 2-hydroxyethylacryloyl phosphate.

Examples of the monomers for the modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl(meth)acrylate monomers such as aminoethyl (meth)acrylate, N,N-dimethylaminoethyl(meth)acrylate, and tert-butylaminoethyl (meth)acrylate; alkoxyalkyl(meth)acrylate monomers such as methoxyethyl(meth)acrylate and ethoxyethyl (meth)acrylate; and succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine.

Examples of the applicable monomers also include vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amides, styrene, α-methylstyrene, and N-vinylcaprolactam; cyanoacrylate monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate.

In terms of adhesion to liquid crystal cells and adhesion durability for optical film applications, hydroxyl group-containing monomers and carboxyl group-containing monomers are preferably used.

The content of the copolymerization monomer in the acrylic polymer is not limited but preferably from about 0.1 to 10% by weight.

Average molecular weight of the acrylic polymer is not limited, but the weight average molecular weight of about 300,000 to 2,500,000 is preferable. The acrylic polymer may be produced by a variety of known methods, for example, by a method appropriately selected from radical polymerization methods including a bulk polymerization method, a solution polymerization method and a suspension polymerization method. A variety of known radical polymerization initiators may be used such as azo initiators and peroxide initiators. The reaction is generally performed at a temperature of about 50° C. to about 80° C. for a time period of 1 to 8 hours. Among the above methods, the solution polymerization method is particularly preferred, and ethyl acetate, toluene, or the like is generally used as an acrylic polymer solvent. The concentration of the solution is generally from about 20 to about 80% by weight.

Examples of the base polymer for rubber-based pressure-sensitive adhesives include natural rubbers, isoprene rubbers, styrene-butadiene rubbers, regenerated rubbers, polyisobutylene rubbers, styrene-isoprene-styrene rubbers, and styrene-butadiene-styrene rubbers. Examples of the base polymer for silicone-based pressure-sensitive adhesives include dimethyl polysiloxane and diphenyl polysiloxane. These base polymers may contain any introduced functional group such as a carboxyl group.

The pressure-sensitive adhesive is preferably prepared as a pressure-sensitive adhesive composition containing a crosslinking agent. A crosslinking agent mixed with the pressure-sensitive adhesive includes a multifunctional compound such as an organic crosslinking agent and a multifunctional metal chelate. Examples of the organic crosslinking agent include epoxy crosslinking agents and isocyanate crosslinking agents and imine crosslinking agents. As to the organic crosslinking agent, an isocyanate crosslinking agent is preferable. The multifunctional metal chelate has a covalent or coordinate bond between a multivalent metal and an organic compound. Examples of the multivalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The acrylic base polymer or other base polymer and the crosslinking agent may be mixed at any mixing ratio. In general, 100 parts by weight of the base polymer (in terms of solids content) is preferably mixed with about 0.01 to about 10 parts by weight of the crosslinking agent (in terms of solids content), more preferably mixed with about 0.1 to about 5 parts by weight of the crosslinking agent (in terms of solids content).

If necessary, the pressure-sensitive adhesive may conveniently contain various types of additives such as tackifiers, plasticizers, fillers such as glass fibers, glass beads, metal power, or any other inorganic powder, pigments, colorants, fillers, antioxidants, ultraviolet absorbers, and silane-coupling agents, without departing from the object of the invention. The pressure-sensitive adhesive layer may also contain fine particles so as to have light diffusion properties.

For example, the pressure-sensitive adhesive is formed into a pressure-sensitive adhesive layer by a process including the steps of applying a pressure-sensitive adhesive solution diluted with a solvent or an aqueous emulsion of a pressure-sensitive adhesive to a release film and drying it to evaporate the solvent or water. Examples of the method of application include roll coating methods such as reverse coating and gravure coating, and other coating methods such as spin coating methods, screen coating methods, fountain coating methods, dipping methods, and spray methods. The pressure-sensitive adhesive layer may have any thickness but preferably has a thickness of about 2 to about 200 μm more preferably of 5 to 100 μm.

Examples of materials for forming the release film include paper, films of synthetic resins such as polyethylene, polypropylene, polyethylene terephthalate, and polyvinyl alcohol, and appropriate thin products such as rubber sheets, paper, fabrics, non-woven fabrics, nets, foamed sheets, metal foils, and any laminates thereof. The release film is preferably formed of a material that is stretchable together with the pressure-sensitive adhesive layer and easily stretchable at room temperature, such as polyvinyl alcohol, polycarbonate, triacetyl cellulose, norbornene resins, and polyethylene. Any other materials may also be used, because stretching may be performed in a heated state at Tg or higher. In order to have increased releasability from the pressure-sensitive adhesive layer, the surface of the release film may be subjected to release treatment for low adhesion, such as silicone treatment, long-chain alkyl treatment, and fluorine treatment, as needed.

The optically-transparent pressure-sensitive adhesive layer may be formed by any of the above adhesives or may be formed by a radiation-curable pressure-sensitive adhesive that contains a vinyl monomer or partial polymerized polymerized polymer thereof (pressure-sensitive adhesive syrup). In a preferred mode, the vinyl monomer is converted into a partial polymerized polymer (pressure-sensitive adhesive syrup with a rate of polymerization of about 5 to about 30%) for forming the pressure-sensitive adhesive layer. A UV-curable pressure-sensitive adhesive may be applied to the release film and exposed to a radiation such as UV so that the pressure-sensitive adhesive layer can be formed similarly to the above.

Examples of the vinyl monomer may include the monomers for forming the acrylic polymer for use in the acrylic-based pressure-sensitive adhesive.

In general, the radiation-curable pressure-sensitive adhesive contains a photo-polymerization initiator. Examples of the initiator include benzoin ethers such as benzoin methyl ether, benzoin isopropyl ether and 2,2-dimethoxy-1,2-diphenylethane-1-one; substituted benzoin ethers such as anisole methyl ether; substituted acetophenones such as 2,2-diethoxyacetophenone, 2,2-dimethoxy-2-phenylacetophenone and 1-hydroxy-cyclohexylphenylketone; substituted alpha-ketols such as 2-methyl-2-hydroxylpropiophenone; aromatic sulfonyl chlorides such as 2naphthalenesulfonyl chloride; and optically active oximes such as 1-phenyl-1,1-propanedion-2-(o-ethoxycarbonyl)-oxime. Based on 100 parts by weight of the vinyl monomer, the photo-polymerization initiator is preferably used in an amount of 0.01 to 5 parts by weight, more preferably of 0.1 to 3 parts by weight.

The radiation-curable pressure-sensitive adhesive for use may contain a crosslinking component having at least two polymerizable functional groups, such as multifunctional (meth)acrylate. Examples of the crosslinking component include trimethylolpropane tri(meth)acrylate, pentaerythritol tetra(meth)acrylate, 1,2-ethylene glycol di(meth)acrylate, 1,6-hexanediol di(meth)acrylate, and 1,12-dodecanediol di(meth)acrylate. The content of the multifunctional (meth)acrylate or the like may vary with its molecular weight, the number of its functional groups or the like. In general, the multifunctional (meth)acrylate or the like is preferably used in an amount of 0.001 to 30 parts by weight, more preferably of 0.05 to 20 parts by weight, based on 100 parts by weight of the vinyl monomer.

The radiation-curable pressure-sensitive adhesive may contain the same additives as those for the above-described adhesives, as far as the photo-polymerization performance is not inhibited. The radiation-curable pressure-sensitive adhesive may be formed into a pressure-sensitive adhesive layer by a process including the steps of applying the radiation-curable pressure-sensitive adhesive to a release film and then exposing it to light. Typically, ultraviolet night providing an illuminance of 1 to 200 mW/cm² at wavelengths from 300 to 400 nm is applied in a quantity of 400 to 4,000 mJ/cm² for photo-polymerization. The pressure-sensitive adhesive layer may have any thickness but is preferably from about 2 to about 200 μm in thickness, more preferably from 5 to 100 μm in thickness, as defined above.

The resulting pressure-sensitive adhesive layer is imparted retardation by stretching. The pressure-sensitive adhesive layer may be separated from the release film and then stretched or may be stretched together with the release film. If the release film is made of a readily stretchable material such as polyvinyl alcohol, the pressure-sensitive adhesive layer should be stretched together with the release film so that the pressure-sensitive adhesive layer can be more uniformly stretched.

The stretching may be performed using a method that includes holding, in chucks, the both ends of the pressure-sensitive adhesive layer or the release film provided with the pressure-sensitive adhesive layer and pulling it in one direction to uniaxially stretch it. Alternatively, a method may be used which include holding the four ends in chucks and pulling in both directions for biaxial stretching. If necessary, the refractive index in the thickness direction may be controlled by a method that includes performing uniaxial or biaxial stretching in the in-plane direction and performing stretching in the thickness direction. The stretching ratio is generally from 1.1 to 7 times, preferably from 1.2 to 6 times. The thickness of the resulting retardation pressure-sensitive adhesive layer is generally from about 2 to about 100 μm, preferably from 5 to 50 μm.

The adhesive layer containing crosslinking component is subjected to a crosslinking process. When the crosslinking component of the pressure-sensitive adhesive is a crosslinking agent such as an isocyanate crosslinking agent and an epoxy crosslinking agent, crosslinking process may be performed by a heating or drying process. After drying, crosslinking process may be facilitated by aging in a heated state or by aging by standing at room temperature. Alternatively, crosslinking process may be performed by electron beam or UV application. The crosslinking component of the radiation-curable adhesive, such as multifunctional (meth)acrylate, may be crosslinked by application of UV or the like.

While the crosslinking process may be performed at any stage, the optically-transparent pressure-sensitive adhesive layer prior to the stretching is preferably in such a state that the crosslinking reaction of the crosslinking component is not completed, and thus the crosslinking reaction is preferably completed after stretching is performed. Before the stretching, the optically-transparent pressure-sensitive adhesive layer is preferably somewhat crosslinked in order to easily have a high retardation. Before the stretching, the optically-transparent pressure-sensitive adhesive layer preferably has a crosslinking percentage of about 10 to about 80%, more preferably of 20 to 70%. After the stretching, crosslinking process is preferably ended at a crosslinking percentage of at least 95%, particularly preferably of 100%. A crosslinking percentage of 100% means a state where the crosslinking agent has completely reacted in the pressure-sensitive adhesive layer and corresponds to the maximum value of the content of the solvent-insoluble components (gel content) in the pressure-sensitive adhesive layer. The crosslinking percentage of the pressure-sensitive adhesive layer in each step may be determined as the relative ratio of the gel content of the pressure-sensitive adhesive layer to the maximum value (crosslinking percentage: 100=gel content of pressure-sensitive adhesive layer: maximum value of gel content of pressure-sensitive adhesive layer). If maximum value of gel content of pressure-sensitive adhesive layer is too high, the tackiness of the pressure-sensitive adhesive layer can be low and the adhesion performance or appearance can be adversely affected. If maximum value of gel content of pressure-sensitive adhesive layer is too low, the crosslink content can be low. En general, therefore, the maximum value of gel content of pressure-sensitive adhesive layer is preferably adjusted to from 40 to 95%, more preferably adjusted to at most 90%. Specifically, the content of the solvent-insoluble components (gel content) is measured by the method described in detail in the section of Examples.

For example, the crosslinking reaction is completed in about 7 days after the pressure-sensitive adhesive, which contains a crosslinking agent (such as an isocyanate crosslinking agent and an epoxy crosslinking agent) as the crosslinking component, is applied. The pressure-sensitive adhesive containing such a crosslinking agent may be formed into a pressure-sensitive adhesive layer by a process including the steps of applying the pressure-sensitive adhesive, then stretching the pressure-sensitive adhesive layer at a stage where the crosslinking percentage reaches the above described values (about 10 to 80%), and then determining aging to complete the crosslinking process. After the stretching, the crosslinking process may be performed by electron beam or UV application.

The retardation pressure-sensitive adhesive layer having a retardation is produced by stretching the pressure-sensitive adhesive layer as described above. The retardation may be controlled by appropriately selecting the composition of the pressure-sensitive adhesive material for forming the pressure-sensitive adhesive layer (the type or average molecular weight of the base polymer and crosslinking agent with respect to general adhesives or the type of the monomer with respect to the radiation-curable adhesives), the degree of crosslinking, additives, or the like. Specifically, when a retardation pressure-sensitive adhesive layer having high retardation is designed using acrylic-based pressure-sensitive adhesive, a high-elastic modulus pressure-sensitive adhesive, which comprises an acrylic copolymer of a high Tg monomer and has an increased crosslinking percentage (the maximum value of the gel content: at least 70%), so as to form a high-gel-content pressure-sensitive adhesive layer, is effectively used. On the other hand, when a retardation pressure-sensitive adhesive layer having low retardation is designed, low-elastic modulus pressure-sensitive adhesive, which comprises a copolymer of a high Tg monomer and has a decreased crosslinking percentage (the maximum value of the gel content: at most 50%), so as to form a low-gel-content, is effectively used. These are an outline, and it is very important to appropriately select materials, because any other material-specific retardation can be expected as well as the elastic modulus-specific effect.

The resulting retardation pressure-sensitive adhesive layer is laminated onto one side or both sides of an optical film to form a pressure-sensitive adhesive optical film (1). The retardation pressure-sensitive adhesive layer formed on a release film may be transferred from the release film and laminated onto the optical film. One or more retardation pressure-sensitive adhesive layers may be laminated. When two or more retardation pressure-sensitive adhesive layers are laminated, the total retardation can be controlled by modulating the retardation of each layer. The pressure-sensitive adhesive layer may be laminated after an antistatic layer is formed.

The pressure-sensitive adhesive optical film (1) is prepared by a process including the steps of forming the retardation pressure-sensitive adhesive layer separately from the optical film and laminating it onto the optical film. Alternatively, a pressure-sensitive adhesive optical film (2) having a specific retardation-exhibiting pressure-sensitive adhesive layer may be produced by a process including the step of stretching a pressure-sensitive adhesive optical film comprising an optical film and an optically-transparent pressure-sensitive adhesive layer (an unstretched pressure-sensitive adhesive layer for forming the retardation pressure-sensitive adhesive layer) laminated on one side or both sides of the optical film in such a manner that the pressure-sensitive adhesive layer is stretched together with the optical film.

In the production of the pressure-sensitive adhesive optical film (2), the optically-transparent pressure-sensitive adhesive layer may be the same as in the production of the retardation pressure-sensitive adhesive layer for the pressure-sensitive adhesive optical film (1) (the same as the above example). In the production of the pressure-sensitive adhesive optical film (2), stretching conditions such as stretch ratio are appropriately determined in consideration of not only the retardation of the pressure-sensitive adhesive layer but also the material of the optical film and performance necessary for the optical film, because the pressure-sensitive adhesive layer is stretched together with the optical film. A preferred process includes the steps of laminating the optically-transparent pressure-sensitive adhesive layer containing crosslinking component onto the optical film in such a state that the crosslinking reaction of the crosslinking component is not completed, stretching them, and then completing the crosslinking reaction of the crosslinking component. The range of the crosslinking percentage is preferably the same as in the production of the retardation pressure-sensitive adhesive layer for the pressure-sensitive adhesive optical film (1).

The optical film for use in the pressure-sensitive adhesive optical film of the invention may be any type of film that has been used to form image displays such as liquid crystal displays. The optical films will be described below, which are basically for use in the pressure-sensitive adhesive optical film (1). Among the optical films as illustrated below, any stretchable optical film may be used for the pressure-sensitive adhesive optical film (2). Among the examples below, optical films prior to stretching (unstretched films) may also be used.

For example, the optical film serves as a polarizing plate. A polarizing plate comprising a polarizer and a transparent protective film provided on one side or both sides of the polarizer is generally used.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As a materials forming the transparent protective film prepared on one side or both sides of the above-mentioned polarizer, with outstanding transparency, mechanical strength, heat stability, moisture cover property, isotropy, etc. may be preferable. For example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming a protective film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; allylate type polymers; polyoxymethylene type polymers; epoxy type polymers; or blend polymers of the above-mentioned polymers may be mentioned. The transparent protective film can be formed as a cured layer made of heat curing type or ultraviolet ray curing type resins, such as acryl based, urethane based, acryl urethane based, epoxy based, and silicone based.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (13) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

In general, a thickness of the protection film, which can be determined arbitrarily, is 1 to 500 μm, especially 5 to 200 μm in viewpoint of strength, work handling and thin layer.

The protective film is preferably as colorless as possible. Thus, a protective film is preferably used which has a film-thickness-direction retardation of −90 nm to +75 nm, wherein the retardation (Rth) is represented by the formula: Rth=[(nx+ny)/(2−nz)]d, wherein nx and my are each a principal refractive index in the plane of the film, nz is a refractive index in the film-thickness direction, and d is the thickness of the film. If a protective film with such a thickness-direction retardation value (Rth) of −90 mm to +75 nm is used, coloring (optical coloring) of the polarizing plate can be almost avoided, which could otherwise be caused by any other protective film. The thickness-direction retardation (Rth) is more preferably from −0 mm to +60 nm, particuarly preferably from −70 nm to +45 mm.

As the transparent protective film, if polarization property and durability are taken into consideration, cellulose based polymer, such as triacetyl cellulose, is preferable, and especially triacetyl cellulose film is suitable. In addition, when transparent protective films are provided on both sides of the polarizer, transparent protective films comprising same polymer material may be used on both of a front side and a back side, and transparent protective films comprising different polymer materials etc. may be used. Isocyanate based adhesives, polyvinyl alcohol based adhesives, gelatin based adhesives, vinyl based latex based, aqueous polyester based adhesives, and etc. may be used for adhesion processing for the above-mentioned polarizers and transparent protective films.

As the opposite side of the polarizing-adhering surface above-mentioned transparent protective film, a film with a hard coat layer and various processing aiming for antireflection, sticking prevention and diffusion or anti glare may be used.

A hard coat processing is applied for the purpose of protecting the surface of the polarization plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarization plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarization plate to disturb visual recognition of transmitting light through the polarization plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linlked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarization plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film.

Further an optical film of the invention may be used as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Especially preferable polarizing plates are; a reflection type polarization plate or a transflective type polarization plate in which a reflective plate or a transflective reflective plate is further laminated onto a polarizing plate of the present invention; an elliptically polarizing plate or a circular polarizing plate in which a retardation plate is further laminated onto the polarizing plate; a wide viewing angle polarization plate in which a viewing angle compensation film is further laminated onto the polarizing plate; or a polarizing plate in which a brightness enhancement film is further laminated onto the polarizing plate.

A reflective layer is prepared on a polarization plate to give a reflection type polarization plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarization plate may be formed using suitable methods, such as a method in which a reflective layer of metal etc. is, if required, attached to one side of a polarization plate through a transparent protective layer etc.

As an example of a reflection type polarization plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarization plate, a reflection plate may also be used as a reflective sheet constituted by preparing a reflective layer on the suitable film for the transparent film. In addition, since a reflective layer is usually made of metal, it is desirable that the reflective side is covered with a protective film or a polarization plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarization plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarization plate. That is, the transflective type polarization plate is useful to obtain of a liquid crystal display of the type that saves energy of light sources, such as a back light, in a well-lighted atmosphere, and can be used with a built-in light source if needed in a comparatively dark atmosphere etc.

A description of the above-mentioned elliptically polarization plate or circularly polarization plate on which the retardation plate is laminated to the polarization plates will be made in the following paragraph. These polarization plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarization plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarization plate in which three-dimensional refractive index is controlled may also preferably compensate (prevent) coloring produced when a screen of a liquid crystal display is viewed from an oblique direction. Circularly polarization plate is effectively used, for example, when adjusting a color tone of a picture of a reflection type liquid crystal display that provides a colored picture, and it also has function of antireflection.

As retardation plates, birefringence films obtained by uniaxial or biaxial stretching polymer materials, oriented films of liquid crystal polymers, and materials in which orientated layers of liquid crystal polymers are supported with films may be mentioned. Although a thickness of a retardation plate also is not especially limited, it is in general approximately from 20 to 150 μm.

As polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, poly sulfones, polyethylene terephthalates, polyethylene naphthalates, polyethersulfones, polyphenylene sulfides, polyphenylene oxides, polyallyl sulfones, polyvinyl alcohols, polyamides, polyimides, polyolefins, polyvinyl chlorides, cellulose type polymers, or bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystalline polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarization plate and an above-mentioned reflected type elliptically polarization plate are laminated plate combining suitably a polarization plate or a reflection type polarization plate with a retardation plate. This type of elliptically polarization plate etc. may be manufactured by combining a polarization plate (reflected type) and a retardation plate, and by laminating them one by one separately in the manufacture process of a liquid crystal display. On the other hand, the polarization plate in which lamination was beforehand carried out and was obtained as an optical film, such as an elliptically polarization plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such viewing angle compensation retardation plate, in addition, a film having birefringence property that is processed by uniaxial stretching or orthogonal bidirectional stretching and a biaxially stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarization plate with which a polarization plate and a brightness enhancement film are adhered together is usually used being prepared in a backside of a liquid crystal cell. A brightness enhancement film shows a characteristic that reflects linearly polarization night with a predetermined polarization axis, or circularly polarization light with a predetermined direction, and that transmits other light, when natural light by back lights of a liquid crystal display or by reflection from a back-side etc., comes in. The polarization plate, which is obtained by laminating a brightness enhancement film to a polarization plate, thus does not transmit light without the predetermined polarization state and reflects it, while obtaining transmitted light with the predetermined polarization state by accepting a light from light sources, such as a backlight. This polarization plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarization plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the night usable for a liquid crystal picture display etc. decreases so much, and a resulting picture displayed becomes dark. A brightness enhancement film does not enter the light with the polarizing direction absorbed by the polarizer into the polarizer but reflects the light Once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided whine maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarization plate as it is, the absorption loss by the polarization plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, talking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarization plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarization plate may consist of multi-layered film of laminated layers of a polarization plate and two of more of optical layers as the above-mentioned separated type polarization plate. Therefore, a polarization plate may be a reflection type elliptically polarization plate or a semi-transmission type elliptically polarization plate, etc. in which the above-mentioned reflection type polarization plate or a transflective type polarization plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In addition, in the present invention, ultraviolet absorbing property may be given to the above-mentioned each layer of the adhesive optical film of the invention, such as the optical film, and the adhesive layer etc., using a method of adding UV absorbents, such as salicylic acid ester type compounds, benzophenol type compounds, benzotriazol type compounds, cyano acrylate type compounds, and nickel complex salt type compounds.

The pressure-sensitive adhesive optical film of the invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other components such as a lighting system and incorporating a driving circuit according to any conventional technique, except that the optical film of the invention is used. Any type of liquid crystal cell may also be used such as a TN type, an STN type and a π type.

Suitable liquid crystal displays, such as liquid crystal display with which the above-mentioned optical film has been located at one side or both sides of the liquid crystal cell, and with which a backlight or a reflective plate is used for a lighting system may be manufactured. In this case, the adhesive optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

The invention is more specifically described by means of the examples below, which are not intended to limit the scope of the invention. It should be noted that “part or parts” and “%” are by weight in each example.

(Content of Solvent-Insoluble Components (Gel Content))

About 1 g of a pressure-sensitive adhesive layer was precisely weighed and immersed in about 40 g of ethyl acetate for 7 days. Thereafter, ethyl acetate-insoluble components were all removed, dried at 130° C. for 2 hours, and measured for weight. The resulting value was substituted into the formula below to give the content of the insoluble components. Content of insoluble components (%)=(weight of insoluble components/weight of pressure-sensitive adhesive before immersion)×100. The maximum value of the gel content was a value at the time when it was determined that the gel content of the final product would not increase any more per day.

(Measurement of Retardation)

The in-plane retardation (Δnd) of the pressure-sensitive adhesive layer was measured using an automatic birefringence analyzer (KOBRA-21ADH manufactured by Oji Scientific Instruments). A series of five samples were measured.

### Example 1

(Preparation of Pressure-Sensitive Adhesive)

To a four-necked flask equipped with a cooling tube, a stirring blade and a thermometer was added a mixture solution of 95.3 parts of butyl acrylate, 4 parts of acrylic acid, 0.5 parts of 4-hydroxybutyl acrylate, 0.2 parts of benzoyl peroxide, and 100 parts of ethyl acetate, and allowed to react at 60° C. for 7 hours to give a solution of an acrylic polymer (with a rate of polymerization of 80% and a weight average molecular weight of 1,800,000 in polystyrene equivalent by GPC) with a solids content of 40%. One part (in terms of solids content) of an isocyanate crosslinking agent (Coronate L manufactured by Nippon Polyurethane Industry Co., Ltd.) was added to 100 parts (in terms of solids content) of the acrylic polymer solution, and ethyl acetate was further added thereto to form a pressure-sensitive adhesive solution with a solids content of 30%.

(Preparation of Pressure-Sensitive Adhesive Layer)

The pressure-sensitive adhesive solution was applied to a release-treated polyvinyl alcohol film (thickness 75 μm) with an applicator and dried at 150° C. for 3 minutes for solvent vaporization to form a pressure-sensitive adhesive layer with a thickness of 150 μm after drying. The pressure-sensitive adhesive layer had a gel content of 50% and a crosslinking percentage of 62.5%. The pressure-sensitive adhesive layer was separated from the release film and measured for retardation (Δnd). The result was Δnd=0 nm.

(Preparation of Retardation Pressure-Sensitive Adhesive Layer)

The resulting pressure-sensitive adhesive layer with the release film was cut into a size of 100 mm×50 mm, and both short sides of the cut were held in chucks. The chucks were pulled in a direction parallel to the long side, and stretching was performed until the long side of the film reached 500 mm (at a stretch ratio of 5 times). The thickness of the pressure-sensitive adhesive layer became 30±1 μm. The polyvinyl alcohol film (the side where the pressure-sensitive adhesive layer was not laminated) was immersed in water as needed and pulled so as to be easily stretched.

Thereafter, the pressure-sensitive adhesive layer was aged under the conditions of 23° C. and 55% RH for 7 days so that the crosslinking reaction was completed. The resulting pressure-sensitive adhesive layer had a gel content of 80% and a crosslinking percentage of 100%. The pressure-sensitive adhesive layer was separated from the release film and measured for retardation (Δnd). The result was Δnd=38±1 nm.

(Preparation of Pressure-Sensitive Adhesive Polarizing Plate)

The resulting retardation pressure-sensitive adhesive layer was laminated onto a polarizing plate (SEG 5424DU manufactured by Nitto Denko Corporation) to obtain a pressure-sensitive adhesive polarizing plate. The resulting adhesive polarizing plate functioned as an elliptically polarizing plate.

### Example 2

(Preparation of Retardation Pressure-Sensitive Adhesive Layer)

A retardation pressure-sensitive adhesive layer was prepared using the process of Example 1 except that the pressure-sensitive adhesive layer was separated from the release film and then stretched alone. The resulting pressure-sensitive adhesive layer had a thickness of 35±5 μm and a retardation Δnd of 40±2 nm.

(Preparation of Pressure-Sensitive Adhesive Polarizing Plate)

The resulting retardation pressure-sensitive adhesive layer was laminated onto a polarizing plate (SEG 5424DU manufactured by Nitto Denko Corporation) to obtain a pressure-sensitive adhesive polarizing plate. The resulting adhesive polarizing plate functioned as an elliptically polarizing plate.

### Example 3

The pressure-sensitive adhesive prepared in Example 1 was applied to a release-treated polyethylene terephthalate film (thickness 38 μm) similarly to Example 1 to form a 150 μm-thick pressure-sensitive adhesive layer, which was then laminated onto a triacetyl cellulose film and separated from the polyethylene terephthalate film. Thereafter, the pressure-sensitive adhesive layer was stretched to 1.5 times under a 150° C. atmosphere. The retardation Δnd of the resulting pressure-sensitive adhesive layer itself (the value calculated by subtracting the retardation of the triacetyl cellulose film) was 5±1 nm.

### Comparative Example 1

(Preparation of Pressure-Sensitive Adhesive Elliptically Polarizing Plate)

The pressure-sensitive adhesive layer (Δnd=0) prepared in Example 1 was laminated onto a polarizing plate (SEG 5424DU manufactured by Nitto Denko Corporation) to obtain a pressure-sensitive adhesive polarizing plate. The resulting adhesive polarizing plate did not function as an elliptically polarizing plate.

1. A retardation pressure-sensitive adhesive layer, comprising a stretched pressure-sensitive adhesive layer obtained by stretching an optically-transparent pressure-sensitive adhesive layer; and the stretched pressure-sensitive adhesive layer has a retardation imparted by stretching.

2. A method of producing the retardation pressure-sensitive adhesive layer according to claim 1, comprising a step of stretching an optically-transparent pressure-sensitive adhesive layer so that a retardation is imparted to the optically-transparent pressure-sensitive adhesive layer by stretching.

3. The retardation pressure-sensitive adhesive layer according to claim 1, wherein the stretched pressure-sensitive adhesive layer has a crosslinked structure.

4. The retardation pressure-sensitive adhesive layer according to claim 3, wherein the optically-transparent pressure-sensitive adhesive layer is formed by a pressure-sensitive adhesive containing a base polymer and a crosslinking agent.

5. A method of producing the retardation pressure-sensitive adhesive layer according to claim 3, comprising steps of: stretching an optically-transparent pressure-sensitive adhesive layer containing a crosslinking component whose crosslinking reaction is not completed; and then completing the crosslinking reaction of the crosslinking component.

6. A pressure-sensitive adhesive optical film, comprising an optical film and at least one layer of the retardation pressure-sensitive adhesive layer according to claim 1 laminated on one side or both sides of the optical film.

7. A method of producing a pressure-sensitive adhesive optical film, comprising a step of stretching a pressure-sensitive adhesive optical film containing an optical film and an optically-transparent pressure-sensitive adhesive layer laminated on one side or both sides of the optical film so that a retardation is imparted to the optically-transparent pressure-sensitive adhesive layer by the stretching.

8. The method of producing a pressure-sensitive adhesive optical film according to claim 7, wherein the optically-transparent pressure-sensitive adhesive layer contains a crosslinking component and is laminated on the optical film in such a state that the crosslinking reaction of the crosslinking component is not completed, and completing the crosslinking reaction of the crosslinking component after the stretching.

9. The method of producing a pressure-sensitive adhesive optical film according to claim 8, wherein the optically-transparent pressure-sensitive adhesive layer is formed by a pressure-sensitive adhesive containing a base polymer and a crosslinking agent.

10. A pressure-sensitive adhesive optical film obtained by the method according to claim 7.

11. An image display, comprising at least one of the pressure-sensitive adhesive optical film according to claim 6.

12. An image display, comprising at least one of the pressure-sensitive adhesive optical film according to claim 10.

13. A method of producing the retardation pressure-sensitive adhesive layer according to claim 4, comprising steps of: stretching an optically-transparent pressure-sensitive adhesive layer containing a crosslinking component whose crosslinking reaction is not completed;
and then completing the crosslinking reaction of the crosslinking component.

14. A pressure-sensitive adhesive optical film, comprising an optical film and at least one layer of the retardation pressure-sensitive adhesive layer according to claim 3 laminated on one side or both sides of the optical film.

15. A pressure-sensitive adhesive optical film, comprising an optical film and at least one layer of the retardation pressure-sensitive adhesive layer according to claim 4 laminated on one side or both sides of the optical film.

16. A pressure-sensitive adhesive optical film obtained by the method according to claim 8.

17. A pressure-sensitive adhesive optical film obtained by the method according to claim 9.

18. An image display, comprising at least one of the pressure-sensitive adhesive optical film according to claim 14.

19. An image display, comprising at least one of the pressure-sensitive adhesive optical film according to claim 15.

20. An image display, comprising at least one of the pressure-sensitive adhesive optical film according to claim 16.

21. An image display, comprising at least one of the pressure-sensitive adhesive optical film according to claim 17.
